(19) United States
(12) Patent Application Publication
(10) Pub. No.: US 2013/0020448 A1
(43) Pub. Date: Jan. 24, 2013

(54) WIRE HOLDING STRUCTURE

(71) Applicants: Ryuta TAKISHITA, Kakegawa-shi (JP); Kazuyuki KAWASHITA, Kakegawa-shi (JP)

(72) Inventors: Ryuta TAKISHITA, Kakegawa-shi (JP); Kazuyuki KAWASHITA, Kakegawa-shi (JP)

(73) Assignee: YAZAKI CORPORATION, Tokyo (JP)

(21) Appl. No.: 13/552,869

(22) Filed: Jul. 19, 2012

(30) Foreign Application Priority Data
Jul. 20, 2011 (JP) 2011-158609

(51) Int. Cl. H02G 3/02

(52) U.S. Cl. 248/74.1

(57) ABSTRACT

An wire holding structure includes a member and a pair of protrusions. The member includes an arranging surface on which the wire is arranged and at least one pair of standing surfaces respectively opposing both sides of the wire. The protrusions are protruded from the standing surfaces respectively opposing the both sides of the wire. The protrusions are disposed at positions which are shifted each other in the arranging direction, so that a gap between the protrusions is larger than a diameter of the wire and a gap between tips of the protrusions projected in the arranging direction is smaller than the diameter of the wire. A distance between the arranging surface and the protrusions is larger than the diameter of the wire.

### BACKGROUND

The present invention relates to a wire holding structure that holds an wire on a surface of a member.

For example, Patent Document 1 discloses a technique which uses a battery module with a plurality of batteries connected in series as a power source for an electric car, a hybrid car or the like. A battery connection plate made of resin formed by holding a plurality of bus bars connecting positive poles and negative poles between adjacent batteries is attached to this type of battery module. In the battery connection plate, a plurality of wires connected to the electrodes of each battery, a high tension cable connected to all the electrodes of the battery module or the like are arranged.

In this manner, in the battery connection plate in which the plurality of wires or the like is arranged, for example, in order to hold the wire in a predetermined arranging direction along the plate, at least a pair of locks is erected on a surface of a base material. The lock includes a pair of leg portions erected toward both sides of a arranging region of the wire, and the opposing surfaces of the respective leg portions are provided with protrusions. A gap smaller than the outer diameter of the wire is provided between the tips of the protrusions, and the wire is press fitted from the gap, so that the wire is held between the surface of the base material and the pair of locks.

However, in a case of holding a plurality of wires having different outer diameters in such an wire holding structure, when press fitting the wire having the large outer diameter, there is a concern that the wire may be damaged. Furthermore, when attempting to press fit such an wire by force, there is concern that the leg portion of the lock may be destroyed. Meanwhile, when holding the wire having the small outer diameter, there is a concern that the wire may escape from the gap between the tips of the protrusions.
[Patent Document 1] JP-A-2004-362997

### SUMMARY

It is therefore one advantageous aspect of the present invention to provide a wire holding structure which prevents the damage to the wire when attaching the wire, and prevents the escape of the wire.

According to one advantage of the invention, there is provided an wire holding structure, comprising:

a member, on which a wire is arranged in an arranging direction, and which includes an arranging surface on which the wire is arranged and at least one pair of standing surfaces respectively opposing both sides of the wire;

a pair of protrusions protruded from the standing surfaces respectively opposing the both sides of the wire, wherein

the protrusions are disposed at positions which are shifted each other in the arranging direction, so that a gap between the protrusions is larger than a diameter of the wire and a gap between tips of the protrusions projected in the arranging direction is smaller than the diameter of the wire, and

a distance between the arranging surface and the protrusions is larger than the diameter of the wire.

The wire holding structure may be configured such that: the standing surfaces are respectively formed in leg portions respectively having a plate shape and standing on a plane identical to the arranging surface, and the protrusions are respectively protruded from the standing surfaces of the leg portions.

The wire holding structure may be configured such that: the arranging surface is a bottom surface of a wire accommodating groove formed in the member, the standing surfaces are a pair of groove side surfaces of the wire accommodating groove which oppose each other, and the protrusions are respectively protruded from the groove side surfaces.

### BRIEF DESCRIPTION OF DRAWINGS

FIGS. 1A and 1B are top view that shows a wire holding structure of a first embodiment to which the present invention is applied. FIG. 1A is a diagram that shows a state when inserting the wire, and FIG. 1B is a diagram that shows a state where the wire is held.

FIGS. 2A and 2B are a top view that shows a wire holding structure of a first embodiment to which the present invention is applied. FIG. 1A is a diagram that shows a state when inserting the wire, and FIG. 1B is a diagram that shows a state where the wire is held.

FIGS. 3A and 3B are diagrams that show a state where the wire is held in an wire holding structure of the related art. FIG. 3A is a top view thereof, and FIG. 3B is a cross-sectional view taken along the line A-A of FIG. 3A.

FIGS. 4A and 4B are diagrams that show a state where the wire is held in an wire holding structure of the related art. FIG. 4A is a top view thereof, and FIG. 4B is a cross-sectional view taken along the line B-B of FIG. 4A.

### DETAILED DESCRIPTION OF EXEMPLIFIED EMBODIMENTS

Hereinafter, an wire holding structure to which the present invention is applied will be described with reference to the drawings. In the embodiment mentioned below, a battery connection plate attached to a battery module serving as the power source of an electric car, a hybrid car or the like is used as a base material, and the wire holding structure formed on the surface of the base material will be described. However, the battery holding structure to which the present invention is applied is not limited to the battery connection plate, and if the wire is arranged on the base material, any base material can be applied without a specific limitation.

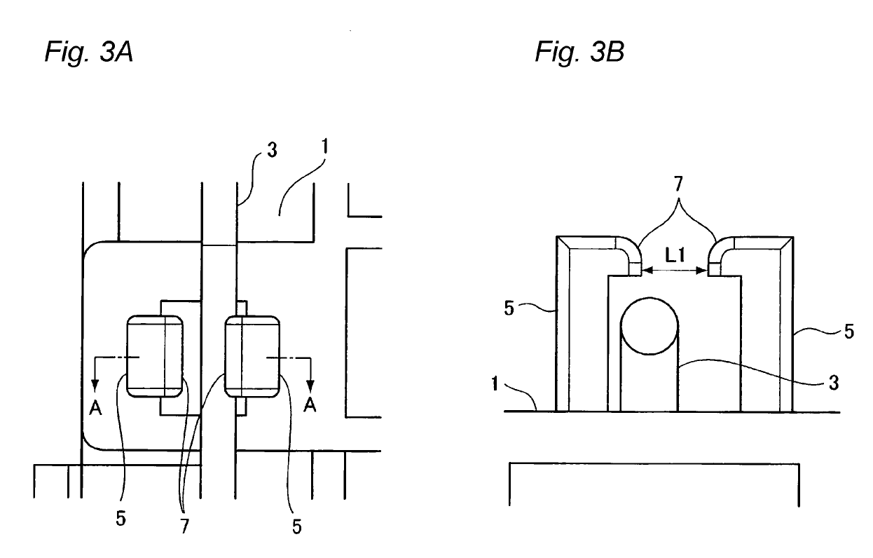

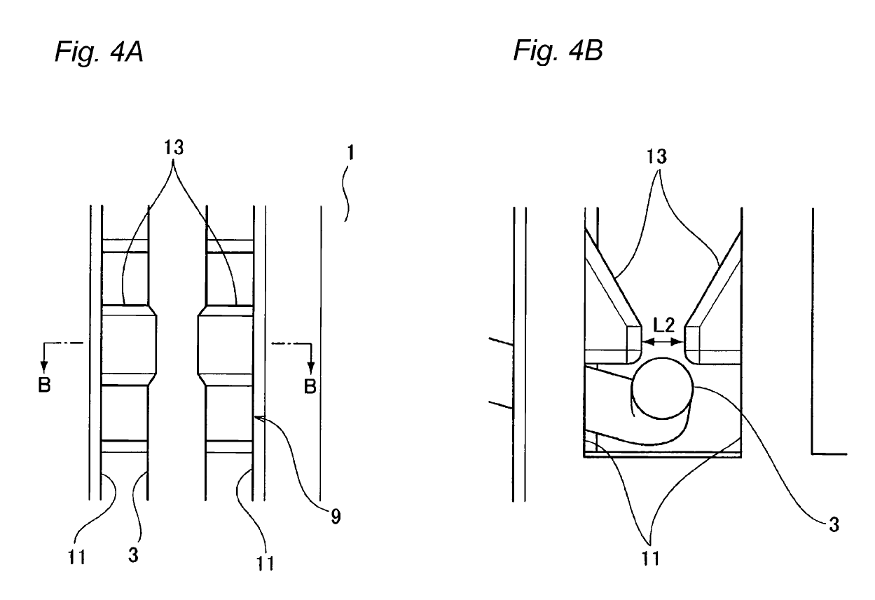

Firstly, in order to facilitate the understanding of the present invention, an wire holding structure of the related art will be described with reference to FIGS. 3A to 4B.

An wire holding structure of FIGS. 3A and 3B holds an wire arranged along a surface of a battery connection plate (hereinafter, referred to as a base material 1) made of resin. In the wire holding structure, a pair of plate-like leg portions 5 is provided so as to oppose each other and be erected on both sides of a arranging region (a region forming a predetermined width along a vertical direction of FIG. 3A) of an wire 3. In a top section of the leg portion 5, protrusions 7 are provided on the opposing surfaces thereof, respectively. A gap between the surface of the base material 1 and an opposing surface (a downward surface of FIG. 3B) of the protrusion 7 opposing the surface of the base material 1 is set to be greater than at least the outer diameter of the wire 3. In addition, the leg portion 5 and the protrusion 7 are formed integrally with the base material 1.

A pair of leg portions 5 and a set of protrusions 7 are provided in the same position of a arranging direction of the wire 3 so as to oppose each other, and a gap L1 (FIG. 3B) between the tips of the protrusions 7 is set to a size smaller than the outer diameter of the wire 3. For this reason, in order to insert and hold the wire 3 between the pair of leg portions 5, there is a need to press fit the wire 3 from the gap between the tips of the protrusions 7.

FIG. 4A shows an wire holding structure of a case where an wire accommodation groove 9 is provided on the surface of the base material 1. A set of protrusions 13 is provided on opposing side walls 11 of the wire accommodation groove 9. A gap between a groove bottom of the wire accommodation groove 9 and an opposing surface (a downward surface of FIG. 4B) of the protrusion 13 opposing the groove bottom is set so as to be greater than the outer diameter of the wire 3. In addition, the protrusions 13 are formed integrally with the base material 1.

The protrusions 13 are provided in the same position of an extending direction (a vertical direction of FIG. 4A) of the wire accommodation groove 9 so as to oppose each other, a gap L2 (FIG. 4B) between the tips of the protrusions 13 is set to a size smaller than the outer diameter of the wire 3. For this reason, in order to insert and hold the wire 3 in the wire accommodation groove 9, there is a need to press fit the wire 3 from the gap between the tips of the protrusions 13.

According to the wire holding structure of FIGS. 3A to 4B, when press fitting the wire 3 from the gap of the tips of the protrusions 7 and 13, the wire 3 may be damaged by being pushed from the tips of the protrusions 7 and 13. For example, in the case of FIGS. 4A and 4B, since the protrusions 13 are provided in the side wall 11 of the wire accommodation groove 9, a gap between the tips of the protrusions 13 is nearly expanded when press fitting the wire 3. For this reason, if the outer diameter of the wire 3 is greater than L2, when press fitting the wire 3, the wire 3 is strongly pushed and is easily damaged.

Meanwhile, in the case of FIGS. 3A and 3B, the protrusions 7 are provided in the leg portion 5, the leg portion 5 is elastically deformed when press fitting the wire 3, and thus the gap between the tips of the protrusions 7 is easily expanded. For this reason, the wire 3 is not damaged, but when attempting to press fit the wire 3 having the large outer diameter by force, the leg portion 5 may be broken.

Furthermore, even in the structure in any one of FIGS. 3A to 4B, when the outer diameter of the wire 3 is smaller than the gap between the tips of the protrusions 7 and 13, some external force is applied to the wire 3 arranged in a arranging region of the wire 3, and if the wire 3 is lifted from the surface of the base material 1 or the groove bottom of the wire accommodation groove 9, there is a concern that the wire 3 may simply escape from the gap between the tips of the protrusions 7 and 13.

Hereinafter, a first embodiment for carrying out the present invention will be described. In addition, in the embodiment mentioned below, the same configurations as those of the related art are denoted by the same reference numerals and the description thereof will be omitted.

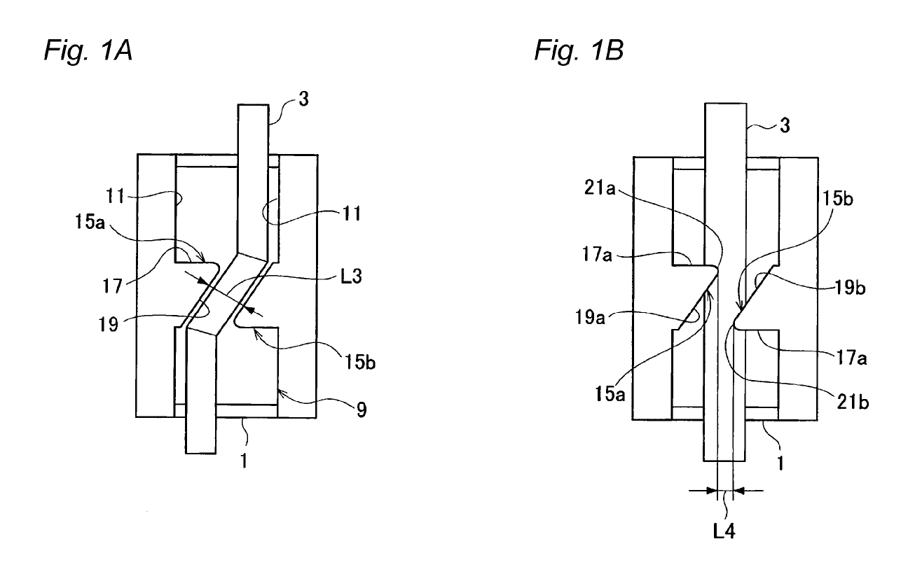

FIGS. 1A and 1B schematically show a wire holding structure according to the present embodiment. In the wire holding structure of the present embodiment, the opposing side walls 11 (standing surfaces) of the wire accommodation groove 9 formed on the surface of the base material 1 (a member) are each formed with protrusions 15a and 15b. A first surface 17 extended substantially vertically from the side wall 11 intersects a second surface 19 extended obliquely from the side wall in the tip section 21 on a cross-section parallel to the extending direction of the wire accommodation groove 9, whereby a set of protrusions 15a and 15b is formed so as to protrude in a V shape. The gap between the groove bottom 23 (an arranging surface) of the wire accommodation groove 9 and the opposing surfaces of the protrusions 15a and 15b opposing the groove bottom is set so as to be greater than the outer diameter of the wire 3.

A set of protrusions 15a and 15b is provided in the tip sections 21a and 21b in the extending direction of the wire accommodation groove 9 so that the positions thereof are shifted, and the gap between the protrusions 15a and 15b is set so as to be greater than the outer diameter of the wire 3. That is, the protrusions 15a and 15b are provided in the extending direction of the wire accommodation groove 9 so as to shift the positions thereof so that the gap L3 formed between the second surfaces 19a and 19b is greater than the outer diameter of the wire 3. Furthermore, a set of protrusions 15a and 15b is set so that a gap L4 between the tips of the protrusions 15a and 15b projected in the extending direction of the wire accommodation groove 9, that is, between the tip sections 21a and 21b is smaller than the outer diameter of the wire 3.

Next, an operation when inserting the wire 3 to the wire holding structure configured in the manner will be described. Firstly, as shown in FIG. 1A, a part of the wire 3 is inserted along the gap formed between the second surfaces 19a and 19b. Herein, since L3 is greater than the outer diameter of the wire 3, even if the wire 3 is not press fitted, the wire 3 can be simply accommodated in the wire accommodation groove 9, and the damage to the wire 3 and the damage to the protrusions 15a and 15b can be prevented.

Next, as shown in FIG. 1B, the wire 3 inserted to the wire accommodation groove 9 is arranged along the arranging region of the wire 3. Herein, since L4 between the protrusions 15a and 15b is smaller than the outer diameter of the wire 3, even if the wire 3 arranged along the wire accommodation groove 9 is lifted by some external force, the wire 3 does not escape from the gap between the protrusions 15a and 15b. In addition, since the gap between the groove bottom 23 and the opposing surfaces of the protrusions 15a and 15b is greater than the outer diameter of the wire 3, the wire 3 accommodated in the wire accommodation groove 9 is accommodated without being pushed to the protrusion 15.

Next, a second embodiment for carrying out the present invention will be described. In addition, since the present embodiment basically has a configuration common to that of the embodiment mentioned above, characteristic configurations will be mainly described, and a description of the common configurations will be omitted.

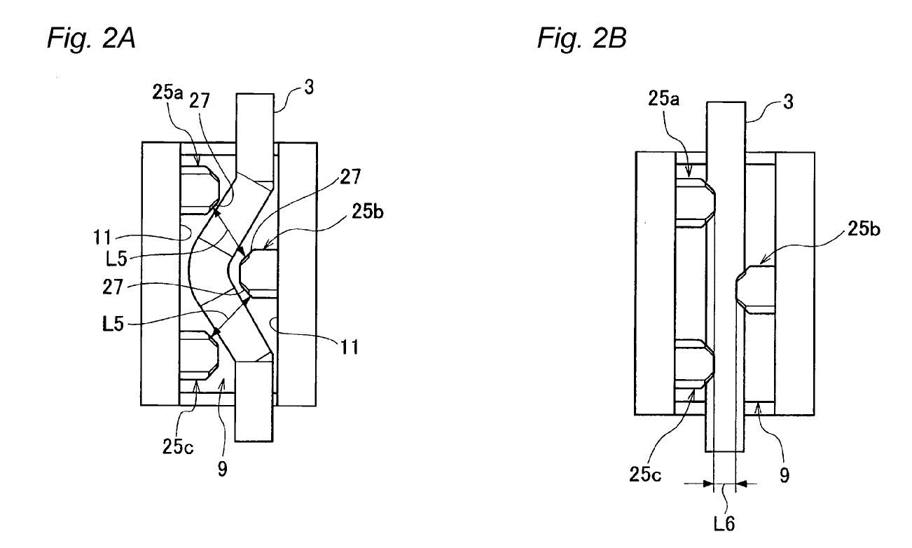

FIGS. 2A and 2B schematically shows an wire holding structure according to the present embodiment. The wire holding structure of the present embodiment is different from the first embodiment in that three protrusions 25a, 25b and 25c are provided in a zig-zag pattern so that the positions thereof are shifted in the extending direction of the wire accommodation groove 9. In the protrusion 25, the cross-section parallel to the extending direction of the wire accommodation groove 9 is different from the cross-sectional shape of the protrusion 15 of FIGS. 1A and 1B, but this is because an insertion surface 27 is included for providing a gap into which the wire 3 is inserted, between the adjacent protrusions 25. Thus, the insertion surface 27 has basically the same function as that of the second surface 19 of the first embodiment.

In the present embodiment, although three protrusions 25 are provided, since the protrusions 25a and 25b form the set and the protrusions 25b and 25c form the set, total two sets of protrusions 25 are provided. For example, the protrusions 25a and 25b are set such that a gap L5 between the insertion surfaces 27 is greater than the outer diameter of the wire 3. Furthermore, the protrusions 53a and 53b projected in the extending direction of the wire accommodation groove 9 are set such that a gap L6 between the tips is smaller than the outer diameter of the wire 3. Such a relationship between the protrusions 25a and 25b is also similarly applied between the protrusion 25b and the protrusion 25c.

According to this, firstly, as shown in FIG. 2A, a part of the wire 3 is bent, and the wires 3 are each inserted along a gap formed between the insertion surfaces 27 of the protrusions 25a and 25b, and a gap formed between the insertion surfaces 27 of the protrusions 25b and 23c. Herein, since the gap L5 formed between the respective insertion surfaces 27 is set to be greater than the outer diameter of the wire 3, even if the wire 3 is not press fitted, the wire 3 can be simply accommodated in the wire accommodation groove 9, and thus it is possible to prevent the damage to the wire 3 and the damage to the protrusions 25a, 25b and 25c.

Next, as shown in FIG. 2B, the wire 3 inserted to the wire accommodation groove 9 is arranged along the arranging region of the wire 3. Herein, since a gap L6 of the protrusions 25a, 25b and 25c is formed to be smaller than the outer diameter of the wire 3, even if the wire 3 arranged along the wire accommodation groove 9 is lifted by some external force, the wire 3 does not escape from the gap of the protrusions 25a, 25b and 25c.

As in the present embodiment, by alternately providing three or more protrusions 25a, 25b and 25c on both sides of the arranging region of the wire 3 while shifting the positions thereof, the wire 3 can be further stably held compared to a case where two protrusions 25 are placed.

Although any of the embodiments mentioned above is applied to the wire accommodation groove 9 formed on the surface of the base material 1 (a plane identical to the arranging surface), as shown in FIGS. 3A and 3B, the present invention can also be applied to a case where the protrusion 7 is provided in the leg portion 5 erected from the surface of the base material 1. For example, the protrusions 25a, 25b and 25c of the second embodiment may respectively protrude from side surfaces (standing surfaces) of the leg portion 5 of the same shape as that of FIG. 3, instead of the side wall 11 of the wire accommodation groove 9. In this case, the leg portions 5 are opposingly erected on both sides of the arranging region of the wire 3, and are provided so that the positions thereof are shifted in the arranging direction.

According to such a configuration, even if the wire 3 is not press fitted, the wire 3 can be simply inserted between the leg portions 5, and it is possible to prevent the damage to the wire 3 and the damage to the leg portions 5. Furthermore, even if the wire 3 arranged along the arranging region of the wire 3 is lifted by some external force, the wire 3 does not escape from the gap between the protrusions.

In the present invention, since the wire can be inserted by using the gap that is formed between the set of protrusions and is greater than the outer diameter of the wire, without press fitting the wire and without deforming the leg portion, it is possible to prevent the damage to the wire. Furthermore, since the set of protrusions are formed so that the gap between the tips of the protrusions projected in the arranging direction of the wire is smaller than the outer diameter of the wire, even if the wire arranged along the arranging region of the member is lifted by some external force, the wire does not escape from the gap of the tip of the protrusion. In this manner, by making the insertion section of the wire and the holding section different from each other, it is possible to provide an electric holding structure in which the damage to the wire is prevented and the wire does not easily escape.

In a configuration that the leg portions standing on the surface of the member are provided, the protrusions may be provided on the opposing surfaces of the leg portions. In this configuration, since the wire can be inserted without press fitting the wire and without deforming the leg portion, it is possible to prevent the damage to the wire.

Furthermore, when an wire accommodation groove is formed on the surface of the member, the protrusions may be provided on the opposing groove side surfaces.

Even in such a configuration, as in a case of providing the protrusions in the leg portion, the wire can be accommodated in the wire accommodation groove without press fitting, and thus the damage to the wire can be prevented. Furthermore, it is possible to prevent the accommodated wire from slipping out from the gap of the tips of the protrusions.

According to the present invention, it is possible to prevent the wire from being damaged when attaching the wire, and it is possible to prevent the wire from slipping out.

As mentioned above, although the embodiments of the present invention have been described in detail with reference to the drawings, the embodiments mentioned above are merely an example of the present invention, and the present invention is not limited only to the configurations of the embodiments mentioned above. The present invention naturally includes design modifications or the like within the scope not departing from the gist of the present invention.

The present application is based on Japanese Patent Application No. 2011-158609 filed on Jul. 20, 2011, the contents of which are incorporated herein by way of reference.

What is claimed is:

1. An wire holding structure, comprising:
a member, on which a wire is arranged in an arranging direction, and which includes an arranging surface on which the wire is arranged and at least one pair of standing surfaces respectively opposing both sides of the wire;
a pair of protrusions protruded from the standing surfaces respectively opposing the both sides of the wire, wherein
the protrusions are disposed at positions which are shifted each other in the arranging direction, so that a gap between the protrusions is larger than a diameter of the wire and a gap between tips of the protrusions projected in the arranging direction is smaller than the diameter of the wire, and
a distance between the arranging surface and the protrusions is larger than the diameter of the wire.

2. The wire holding structure according to claim 1, wherein
the standing surfaces are respectively formed in leg portions respectively having a plate shape and standing on a plane identical to the arranging surface, and
the protrusions are respectively protruded from the standing surfaces of the leg portions.

3. The wire holding structure according to claim 1, wherein
the arranging surface is a bottom surface of a wire accommodating groove formed in the member,
the standing surfaces are a pair of groove side surfaces of the wire accommodating groove which oppose each other, and
the protrusions are respectively protruded from the groove side surfaces.
